(19) United States
(12) Patent Application Publication
(10) Pub. No.: US 2021/0028746 A1
(43) Pub. Date: Jan. 28, 2021

(54) METHOD FOR MECHANICAL LOAD TESTING OF PHOTOVOLTAIC MODULES WITH CONCURRENTLY APPLIED STRESSORS AND DIAGNOSTIC METHODS

(71) Applicant: Alliance for Sustainable Energy, LLC, Golden, CO (US)

(72) Inventor: Peter Ludwig HACKE, Golden, CO (US)

(21) Appl. No.: 16/938,268

(22) Filed: Jul. 24, 2020

Related U.S. Application Data
(60) Provisional application No. 62/878,151, filed on Jul. 24, 2019.

(51) Int. Cl. H02S 50/10; H02S 40/20; B32B 41/00

(52) U.S. Cl. CPC H02S 50/10; B32B 2457/12; B32B 41/00; H02S 40/20

(57) ABSTRACT

Disclosed herein are improved methods for applying rapid mechanical loading to a photovoltaic module to better simulate the rapid displacements exhibited by photovoltaic modules under wind loading.

### CROSS-REFERENCE TO RELATED APPLICATIONS

This application claims priority under 35 U.S.C. § 119 to U.S. provisional patent application No. 62/878,151 filed on 24 Jul. 2019, the contents of which are hereby incorporated in their entirety.

### CONTRACTUAL ORIGIN

The United States Government has rights in this invention under Contract No. DE-AC36-08G028308 between the United States Department of Energy and Alliance for Sustainable Energy, LLC, the Manager and Operator of the National Renewable Energy Laboratory.

### BACKGROUND

The HAST acronym stands for Highly Accelerated Stress Testing. HAST makes use of accelerated temperature, humidity, and other stressors that may include optical, thermal, hydrolytic, and electrolytic stresses to precipitate failures which could be caused by long term exposure to stresses.

There is currently no solution for highly accelerated stress testing photovoltaic (PV) modules that meets the needs of being fast and having no contact with, and/or not obscuring, the active cell area of a PV module.

Existing methods for stressor testing of PV modules allow for testing of only one side at a time and/or allow for the testing of only one aspect of the photovoltaic module. For example, mechanical loading of PV modules is currently carried out by application of weight to the module surface. Mechanical loading of the PV module can also occur by using vacuum or pressure with or without a bladder, or by using vacuum with the use of suction cups. These methods impart stresses at a slow speed and also obstruct the view of the module.

### SUMMARY

In an aspect, disclosed herein are methods for testing photovoltaic modules comprising providing a force at the edge of a module in order to impart a momentum onto a laminate of the module and measuring the magnitude and/or frequency of the displacement of the laminate. In an embodiment, the force is applied by electromagnetic, electro-mechanical or piezoelectric means. In another embodiment, the force is applied with position-adjustable mechanical stops. In an embodiment, the displacement of the laminate is measured by optical, electrical or physical sensing means. In an embodiment, the sensing means comprise a linear variable differential transformer, a laser and/or a strain gauge. In an embodiment, the method further involves unobstructed electro-optical and/or optical observation of the photovoltaic module during the application of the force. In an embodiment, the method tests for the effect of the application of optical, thermal, hydrolytic, and/or electrolytic stresses to the module. In an embodiment, the magnitude and frequency of the displacement of the laminate comprises highly accelerated stress testing. In an embodiment, the magnitude applied to the edge of the module simulate wind loading of the module.

In an aspect, disclosed is a method for testing photovoltaic modules comprising providing a force at the edge of a photovoltaic module in order to impart a momentum onto a laminate of the photovoltaic module and measuring the magnitude of the displacement of the laminate. In an embodiment, the method comprises measuring the frequency of the displacement of the laminate. In an embodiment, the force is applied by electromagnetic, electro-mechanical or piezoelectric means. In an embodiment, the force is applied with position-adjustable mechanical stops at the edge of the photovoltaic module. In an embodiment, the displacement of the laminate is measured by optical, electrical or physical sensing means. In an embodiment, the optical sensing means comprise a laser. In an embodiment, the electrical sensing means comprise a strain gauge. In an embodiment, the physical sensing means comprise a linear variable differential transformer. In an embodiment, the method further comprises unobstructed observation of the photovoltaic module during the application of the force. In an embodiment, the observation comprises optical or electric-optical means. In an embodiment, the method further comprises the application of stresses to the photovoltaic module wherein the stresses are selected from the group consisting of optical, thermal, hydrolytic, and electrolytic stresses. In an embodiment, the magnitude and frequency of the displacement of the laminate comprises highly accelerated stress testing. In an embodiment, the frequency and the magnitude of the force applied to the edge of the photovoltaic module simulate wind loading of the photovoltaic module.

In an aspect, disclosed herein is a device configured to apply a force to the edge of a photovoltaic module that causes a displacement through the photovoltaic module; and wherein the device is further configured to stop the displacement of the photovoltaic module at an edge of the photovoltaic module; and wherein the device is configured to allow an unobstructed view of the active cell area of the photovoltaic module. In an embodiment, the magnitude and frequency of the displacement of the photovoltaic module is measured through optical, electrical or physical sensing means. In an embodiment, the optical sensing means comprise a laser. In an embodiment, the electrical sensing means comprise a strain gauge. In an embodiment, the physical measurement means comprise a linear variable differential transformer.

In in aspect, disclosed herein is a method for measuring the performance of a photovoltaic module while applying a force to the photovoltaic module caused by the exposure of the photovoltaic module to wind. In an embodiment, the performance of the photovoltaic module is measured by the effect of the force on its electrical output while being exposed to conditions comprising different wavelengths of light, different quanta of light, different temperatures, and different shading patterns of light cast upon the photovoltaic module.

Other objects, advantages, and novel features of the present invention will become apparent from the following detailed description of the invention when considered in conjunction with the accompanying drawings.

### DETAILED DESCRIPTION

Disclosed herein are methods for testing of photovoltaic modules while simultaneously applying stressors. In an embodiment, methods for HAST are disclosed that use the PV module's own momentum to create the required displacement of the laminate of the PV module for testing to simulate wind loading and other stressors. Using methods disclosed herein, the performance of the active area of the PV module can be measured while the PV module's response to applied stressors is simultaneously being tested.

Comprehensive design testing of PV modules is problematic, in that lab-derived tests, at best, generally approximate the real world operating conditions that PV modules face in the field. For example, load bearing tests (relevant for environments in which high wind or snow loading is commonplace) are challenging to replicate because currently used techniques cannot, for instance, replicate the high frequency vibration experienced in high winds while also thermally stressing the module (simulating high temperatures) and concurrently stressing the module with water ingress due to the way these tests physically obstruct or block parts of the device. The testing of individual stressors in isolation does not accurately replicate real world situations.

In an embodiment, disclosed is a novel device for mechanical load testing of PV modules which rapidly vibrates the module based on connections at the module edges (or frame), and which rapidly displaces the frame, thereby using the module's own momentum to initiate displacement across the breadth of the cell. This leaves the PV module surface available to apply other stressors (e.g. heat, moisture, light, voltage) in conjunction with the mechanical stress. In an embodiment, disclosed herein are methods for HAST at frequencies ranging from about 25 to about 400 Hz.

In an embodiment, the devices disclosed herein apply a mechanical load to PV modules in such a way that the active cell area of the module laminate is not obstructed from view or contacted in any way. The device applies displacement and stops of displacement at the module edges (including frame) rapidly so that the momentum of the PV module laminate contained within is loaded and displaced by its own momentum. In an embodiment, the actuation is accomplished by electromagnetic, electro-mechanical, or piezoelectric-based actuators applied to the module edges connected to a circuit which drives the magnitude and frequency of the displacements, and with position-adjustable mechanical stops that cause the module laminate to be displaced by its own momentum. The displacement may be monitored by optical (e.g. laser), electrical (strain gauge), or physical sensing means such as a linear variable differential transformer (LVDT).

As disclosed herein, the testing methods provide an unobstructed optical path to both sides of the module laminate during loading for illumination, electro-optical testing, or optical inspection, unlike existing PV module mechanical testing tools.

In an embodiment, the methods and devices disclosed herein allow for the application of rapid mechanical loading to the module, allowing for better simulation of the rapid displacements exhibited by modules under wind loading when compared to existing PV module mechanical testing tools.

The methods disclosed herein allow for concurrently applying multiple stressors to the PV module including, but not limited to, optical, thermal, hydrolytic, and electrolytic stressors. In an embodiment, even under the application of multiple stressors simultaneously, the response of the full active portion of the PV module can be measured.

The frequency of a wind load can't be tested using current methods. Using the methods disclosed herein, HAST can be performed. The highly accelerated stress testing can approximate the stresses applied to the photovoltaic module that would take place over the course of years.

Using the testing methods and devices disclosed herein, the modules can be tuned in a controlled environment according to any chosen testing parameter or parameters. In an embodiment, the testing methods and devices disclosed herein are useful for replicating the stresses applied to a module by wind at various speeds. A force is applied to at least a side of the module and the deflection of the module is measured. By changing the direction, amount and time that the force is applied, the module's response to, for example, various wind speeds can be tested over multiple cycles.

An advantage to using the methods and devices as disclosed herein is that simultaneous to being tested for stressors that approximate forces that a wind speed would apply to the module, the module can be simultaneous tested for its response to other stressors and environmental conditions on one or both sides of the module. For example, by using the methods as disclosed herein, light could be cast upon the module while a force is being applied to the module that approximates a wind and the output of the module could be tested for its response under various wavelengths of light, quanta of light, at various temperatures, under various shading patterns, and being covered or partially covered by various substances (dirt, sand, snow, bird droppings, etc.).

The methods disclosed herein are not limited to being used for an essentially flat module and may be applied to modules of any shape or morphology. The methods disclosed herein may also be applied to test the effects of highly accelerated stresses on any material. In an embodiment, the methods disclosed herein are useful for testing photovoltaic modules that are sandwiched in between glass or any other hard material. In an embodiment, the methods disclosed herein can be applied to any module that has a laminate or other covering whose deflection can be measured.

The foregoing disclosure has been set forth merely to illustrate the invention and is not intended to be limiting.

We claim:

1. A method for testing photovoltaic modules comprising providing a force at the edge of a photovoltaic module in order to impart a momentum onto a laminate of the photovoltaic module and measuring the magnitude of the displacement of the laminate.

2. The method of claim 1 further comprising measuring the frequency of the displacement of the laminate.

3. The method of claim 1 wherein the force is applied by electromagnetic, electro-mechanical or piezoelectric means.

4. The method of claim 3 wherein the force is applied with position-adjustable mechanical stops at the edge of the photovoltaic module.

5. The method of claim 1 wherein the displacement of the laminate is measured by optical, electrical or physical sensing means.

6. The method of claim 5 wherein the optical sensing means comprise a laser.

7. The method of claim 5 wherein the electrical sensing means comprise a strain gauge.

8. The method of claim 5 wherein the physical sensing means comprise a linear variable differential transformer.

9. The method of claim 1 further comprising unobstructed observation of the photovoltaic module during the application of the force.

10. The method of claim 9 wherein the observation comprises optical or electric-optical means.

11. The method of claim 9 further comprising the application of stresses to the photovoltaic module wherein the stresses are selected from the group consisting of optical, thermal, hydrolytic, and electrolytic stresses.

12. The method of claim 2 wherein the magnitude and frequency of the displacement of the laminate comprises highly accelerated stress testing.

13. The method of claim 2 wherein the frequency and the magnitude of the force applied to the edge of the photovoltaic module simulate wind loading of the photovoltaic module.

14. A device configured to apply a force to the edge of a photovoltaic module that causes a displacement through the photovoltaic module; and wherein the device is further configured to stop the displacement of the photovoltaic module at an edge of the photovoltaic module; and wherein the device is configured to allow an unobstructed view of the active cell area of the photovoltaic module.

15. The device of claim 14 wherein the magnitude and frequency of the displacement of the photovoltaic module is measured through optical, electrical or physical sensing means.

16. The device of claim 14 wherein the optical sensing means comprise a laser.

17. The device of claim 14 wherein the electrical sensing means comprise a strain gauge.

18. The device of claim 14 wherein the physical measurement means comprise a linear variable differential transformer.

19. A method for measuring the performance of a photovoltaic module while applying a force to the photovoltaic module caused by the exposure of the photovoltaic module to wind.

20. The method of claim 19 wherein the performance of the photovoltaic module is measured by the effect of the force on its electrical output while being exposed to conditions comprising different wavelengths of light, different quanta of light, different temperatures, and different shading patterns of light cast upon the photovoltaic module.
